(19) United States
(12) Patent Application Publication
(10) Pub. No.: US 2016/0126012 A1
(43) Pub. Date: May 5, 2016

(54) MULTILAYER CERAMIC CAPACITOR AND METHOD OF MANUFACTURING THE SAME

(71) Applicant: SAMSUNG ELECTRO-MECHANICS CO., LTD., Suwon-Si (KR)

(72) Inventors: Byung Soo KIM, Suwon-Si (KR); Jong Ho LEE, Suwon-Si (KR); Min Sung SONG, Suwon-Si (KR); Ji Hun JEONG, Suwon-Si (KR)

(21) Appl. No.: 14/859,176

(22) Filed: Sep. 18, 2015

(30) Foreign Application Priority Data
Nov. 5, 2014 (KR) 10-2014-0153099

(51) Int. Cl. H01G 4/12; H01G 4/012

(52) U.S. Cl. CPC H01G 4/12; H01G 4/012

(57) ABSTRACT

A method of manufacturing a multilayer ceramic capacitor includes stacking dielectric sheets on which internal electrode patterns are printed, to form a multilayer body, forming additional dielectric sheets on portions of opposite side surfaces of the multilayer body, and sintering the multilayer body to form a ceramic body in which internal electrodes are disposed. Here, the additional dielectric sheets form attachment parts on the opposite side surfaces of the ceramic body by the sintering of the multilayer body.

### CROSS-REFERENCE TO RELATED APPLICATION

This application claims the priority and benefit of Korean Patent Application No. 10-2014-0153099 filed on Nov. 5, 2014, with the Korean Intellectual Property Office, the disclosure of which is incorporated herein by reference.

### BACKGROUND

The present disclosure relates to a multilayer ceramic capacitor, a method of manufacturing the same, and a board having the same.

In accordance with the miniaturization of electronic products, it is demanded to allow multilayer ceramic capacitors to have a sub-miniature size and ultra high capacitance.

Therefore, various methods for thinning and stacking dielectric layers and internal electrodes have been conducted. Recently, high capacitance has been implemented through the manufacture of multilayer ceramic capacitors having increased thickness in comparison with a width thereof.

### SUMMARY

An aspect of the present disclosure may provide a multilayer ceramic capacitor having improving reliability through the prevention of leaning and tombstone defects when the multilayer ceramic capacitor is mounted on a board, while also allowing for the implementation of high capacitance, and a method of manufacturing the same.

According to an aspect of the present disclosure, a method of manufacturing a multilayer ceramic capacitor may include forming additional dielectric sheets on portions of opposite side surfaces of a multilayer body, providing an organic material on regions of the opposite side surfaces of the additional multilayer body in which the dielectric sheets are not formed, and sintering the multilayer body to remove the organic material. Here, the additionally formed dielectric sheets may form attachment parts on the opposite side surfaces of a ceramic body through the sintering of the multilayer body.

According to another aspect of the present disclosure, a multilayer ceramic capacitor may include a ceramic body including dielectric layers and satisfying T/W>1.0, in which W is a width of the ceramic body and T is a thickness of the ceramic body, internal electrodes disposed in the ceramic body, and attachment parts disposed on opposite side surfaces of the ceramic body in a width direction of the ceramic body and being formed to a height less than a thickness of the ceramic body. The attachment parts may be configured of dielectric layers.

According to another aspect of the present disclosure,

A method of manufacturing a multilayer ceramic capacitor, the method comprising, alternatively stacking a plurality of dielectric sheets and a plurality of internal electrode patterns, so as to form a multilayer body, forming additional dielectric sheets on a portion of each of opposite side surfaces of the multilayer body in a stacking direction of the plurality of dielectric sheets and the plurality of internal electrode patterns, forming organic layers on the remaining portions of the opposite surfaces where the additional dielectric sheets are not formed, and sintering the multilayer body, the additional dielectric sheets, and the organic layers. The organic layers may be removed by sintering.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a partially cut-away perspective view schematically illustrating a multilayer ceramic capacitor according to an exemplary embodiment in the present disclosure;

FIG. 2 is a cross-sectional view of the multilayer ceramic capacitor of FIG. 1 taken in a width-thickness (W-T) direction;

FIGS. 3 through 8B are cross-sectional views and perspective views schematically illustrating a method of manufacturing a multilayer ceramic capacitor according to another exemplary embodiment in the present disclosure; and

FIG. 9 is a perspective view illustrating a form in which the multilayer ceramic capacitor of FIG. 1 is mounted on a printed circuit board.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

### Multilayer Ceramic Capacitor

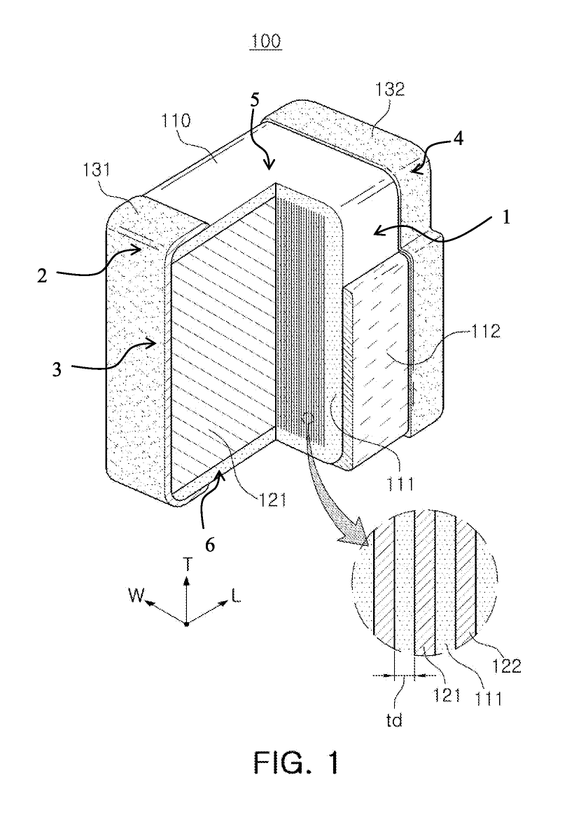

FIG. 1 is a partially cut-away perspective view schematically illustrating a multilayer ceramic capacitor according to an exemplary embodiment in the present disclosure.

Referring to FIG. 1, a multilayer ceramic capacitor 100, according to the exemplary embodiment in the present disclosure, may include a ceramic body 110 including dielectric layers 111; internal electrodes 121 and 122 disposed in the ceramic body 110; and attachment parts 112 disposed on opposite side surfaces 1 and 2 of the ceramic body 110 in a width direction.

In the multilayer ceramic capacitor, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The ceramic body 110 maybe formed as a hexahedron having opposite end surfaces 3 and 4 in a length (L) direction, the opposite side surfaces 1 and 2 in a width (W) direction, and upper and lower surfaces 5 and 6 in a thickness (T) direction.

When a length of the ceramic body 110 is defined as L, a width thereof is defined as W (see FIG. 2), and a thickness thereof is defined as T (see FIG. 2), T/W may satisfy T/W>1.0. In detail, the thickness of the ceramic body 110 may be greater than the width W thereof.

General multilayer ceramic electronic components are manufactured so that a width thereof and a thickness thereof are almost equal to each other.

However, in the multilayer ceramic capacitor according to the exemplary embodiment in the present disclosure, an area of an overlapping region between the internal electrodes may be increased by increasing the thickness of the ceramic body so as to be greater than the width thereof while stacking the internal electrodes in the width direction, such that when the electronic components are mounted on a board, even though areas occupied by the electronic components are the same as each other, the multilayer ceramic capacitor according to the exemplary embodiment in the present disclosure may have higher capacitance.

However, in a case in which a ceramic body is formed to have a thickness greater than a width thereof, as in an exemplary embodiment of the present disclosure, a high degree of capacitance may be secured therein, but since the center of gravity of a multilayer ceramic capacitor may be raised, when the multilayer ceramic capacitor is mounted on the board, an electronic component may be inclined in a taping pocket during a pick-up process, such that a defect in which the electronic component is not picked up may occur, or an electronic component leaning phenomenon may frequently occur when the multilayer ceramic capacitor is mounted on a board.

Further, when the multilayer ceramic capacitor is mounted on the board, a tombstone defect, a phenomenon caused by an electronic component standing up vertically due to the surface tension of solder, leading, for example, to a manufacturing defect such as a Manhattan phenomenon, may occur.

Therefore, according to the exemplary embodiment in the present disclosure, the above-mentioned problem may be solved by the attachment parts 112 being formed to a height lower than the thickness of the ceramic body 110 and being formed on the opposite side surfaces 1 and 2 of the ceramic body 110 in the width (W) direction.

The ceramic body 110 may include the dielectric layers 111 and the internal electrodes 121 and 122 disposed to face each other with each of the dielectric layers 111 interposed therebetween.

The dielectric layers 111 may be in a sintered state, and adjacent dielectric layers 111 may be integrated with each other so that boundaries therebetween are not readily apparent without the use of a scanning electron microscope (SEM).

Raw material forming the dielectric layers 111 is not particularly limited as long as sufficient capacitance may be obtained, but may be, for example, barium titanate (BaTiO₃) powder.

An average thickness td of the dielectric layers 111 may be optionally changed according to the capacitance design of the multilayer ceramic capacitor 100, but may be 0.1 μm to 0.8 μm after sintering.

The average thickness td of the dielectric layers 111 may be measured from an image obtained by scanning a cross-section of the ceramic body 110 in the width direction with the scanning electron microscope (SEM).

The internal electrodes 121 and 122, which are a pair of internal electrodes having different polarities from each other, may be disposed to face each other in the width (W) direction of the ceramic body 110 with each of the dielectric layers 111 interposed therebetween.

The internal electrodes 121 and 122 may be alternately exposed to the opposite end surfaces 3 and 4 of the ceramic body 110 in the length (L) direction of the ceramic body 110 to thereby be connected to external electrodes 131 and 132 formed on the opposite end surfaces 3 and 4 of the ceramic body 110, respectively.

A stacking direction of the internal electrodes 121 and 122 may be the width (W) direction of the ceramic body 110, and in a case in which the multilayer ceramic capacitor is mounted on a board as described below, the multilayer ceramic capacitor may be mounted on the board so that the internal electrodes are disposed perpendicular to the board.

The internal electrodes 121 and 122 are not particularly limited, but may be formed using a conductive paste formed of, for example, any one or more of nickel (Ni), copper (Cu), palladium (Pd), and silver (Ag).

An average thickness of the internal electrodes 121 and 122 after sintering is not particularly limited as long as capacitance may be formed. For example, the average thickness may be 0.6 μm or less.

The average thickness of the internal electrodes 121 and 122 may be measured from the image obtained by scanning the cross-section of the ceramic body 110 in the width direction with the scanning electron microscope (SEM).

The numbers of stacked dielectric layers 111 and internal electrodes 121 and 122 may be increased by decreasing the average thicknesses of the dielectric layers 111 and internal electrodes 121 and 122, and thus higher capacitance may be implemented.

Meanwhile, according to the exemplary embodiment in the present disclosure, the attachment parts 112 formed to a height lower than a thickness of the ceramic body 110 may be formed on the opposite side surfaces 1 and 2 of the ceramic body 110 in the width (W) direction, such that leaning or tombstone defects that may occur at the time of mounting the multilayer ceramic capacitor 100 having high capacitance due to the ceramic body 110 formed to have a thickness T larger than a width W on a board may be prevented.

The attachment parts 112 may be configured of dielectric layers containing a dielectric material, and a raw material forming the attachment parts 112 is not particularly limited. For example, the raw material forming the attachment parts 112 may be barium titanate (BaTiO₃) powder.

The attachment parts 112 maybe formed of substantially the same material as that of the dielectric layers 111 forming the ceramic body 110. However, the raw material of the attachment parts 112 is not necessarily limited thereto.

FIG. 2 is a cross-sectional view of the multilayer ceramic capacitor of FIG. 1 taken in a width-thickness (W-T) direction.

Referring to FIG. 2, in the multilayer ceramic capacitor 100, according to the exemplary embodiment in the present disclosure, a height Ta of the attachment part 112 may be less than the thickness T of the ceramic body 110.

For example, when the height of the attachment part 112 is defined as Ta, Ta/T may satisfy 0.05≦Ta/T≦0.97.

Prevention of leaning and tombstone defects when the multilayer ceramic capacitor 100 having high capacitance is mounted on the board may be further improved by adjusting a ratio Ta/T of the height Ta of the attachment part 112 to the thickness T of the ceramic body 110 so as to satisfy 0.05≦Ta/T≦0.97.

In a case in which the ratio Ta/T of the height Ta of the attachment part 112 to the thickness T of the ceramic body 110 is less than 0.05, when the multilayer ceramic capacitor 100 is mounted on the board, the leaning defect may occur, warpage may occur in the attachment part 112, or cracks may be generated, such that reliability may be deteriorated.

Meanwhile, in a case in which the ratio Ta/T of the height Ta of the attachment part 112 to the thickness T of the ceramic body 110 is more than 0.97, when the multilayer ceramic capacitor 100 is mounted on the board, leaning or tombstone defects may occur.

Further, when a sum of widths of the ceramic body 110 and the attachment parts 112 is defined as Wb, W/Wb may satisfy 0.90≦W/Wb≦0.97.

Prevention of the leaning and tombstone defects when the multilayer ceramic capacitor 100 having high capacitance is mounted on the board may be further improved by adjusting a relationship between the width W of the ceramic body 110 and the width of the attachment parts 112 so as to satisfy 0.90≦W/Wb≦0.97.

In a case in which a ratio W/Wb of the width W of the ceramic body 110 to the sum Wb of the widths of the ceramic body 110 and the attachment parts 112 is less than 0.90, a moisture resistance defect may occur, such that reliability may be deteriorated.

Meanwhile, in a case in which the ratio W/Wb of the width W of the ceramic body 110 to the sum Wb of the widths of the ceramic body 110 and the attachment parts 112 is more than 0.97, when the multilayer ceramic capacitor is mounted on the board, leaning or tombstone defects may occur.

### Method of Manufacturing Multilayer Ceramic Capacitor

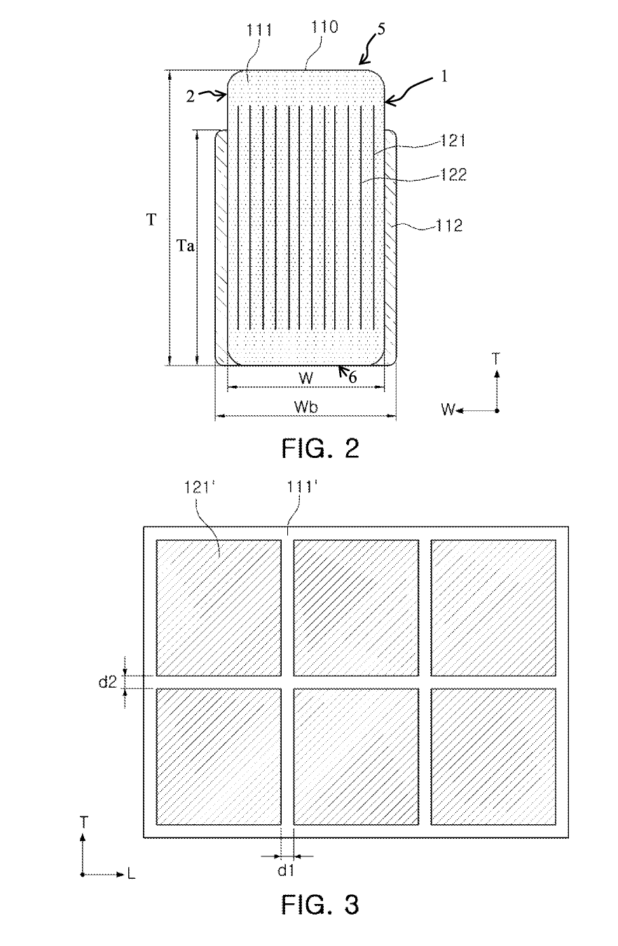

FIGS. 3 through 8B are cross-sectional views and perspective views schematically illustrating a method of manufacturing a multilayer ceramic capacitor according to another exemplary embodiment in the present disclosure.

First, as illustrated in FIG. 3, a plurality of internal electrode patterns 121′ may be formed on a dielectric sheet 111′, having predetermined intervals d1 therebetween in the length direction and predetermined intervals d2 therebetween in the thickness direction.

The plurality of internal electrode patterns 121′ may be arranged in a matrix form.

The dielectric sheet 111′ may be formed of a ceramic paste containing ceramic powder, an organic solvent, and an organic binder.

The ceramic powder may be a material having high permittivity, and a barium titanate (BaTiO₃)-based material, a lead complex perovskite-based material, a strontium titanate (SrTiO₃)-based material, or the like, may be used, and among them, barium titanate (BaTiO₃) powder may be preferable. However, the ceramic powder is not limited thereto.

The internal electrode pattern 121′ may be formed of an internal electrode paste containing a conductive metal. The conductive metal may be nickel (Ni), copper (Cu), palladium (Pd), silver (Ag), or an alloy thereof, but is not limited thereto.

A formation method of the internal electrode pattern 121′ on the dielectric sheet 111′ is not particularly limited.

For example, the internal electrode pattern 121′ may be formed on the dielectric sheet 111′ by a printing method such as a screen printing method or a gravure printing method.

Further, although not illustrated, a plurality of other internal electrode patterns 122′ may be formed on another dielectric sheet 111′ having predetermined intervals therebetween.

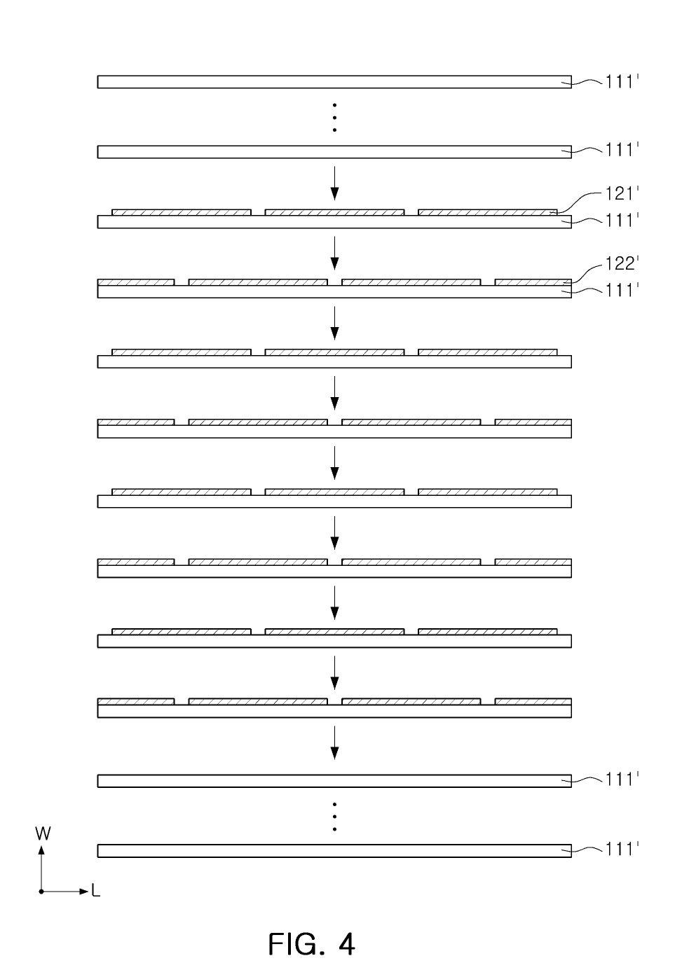

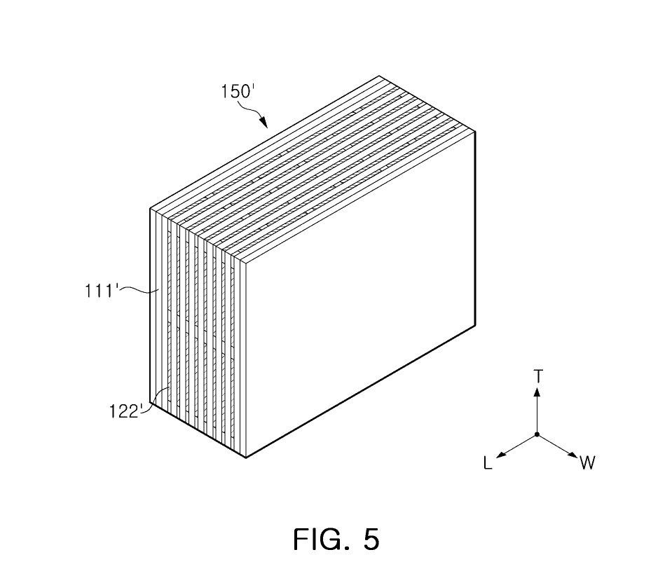

Referring to FIG. 4, the dielectric sheets 111′ may be stacked so that the internal electrode patterns 121′ and 122′ are alternately stacked, such that a multilayer body 150′ may be formed as illustrated in FIG. 5.

A stacking direction of the dielectric sheets 111′ and the internal electrode patterns 121′ and 122′ may be the same as the width direction.

The dielectric sheets 111′ on which the internal electrode patterns 121′ and 122′ are formed may be stacked, and additional dielectric sheets 111′ for forming a cover may be stacked on upper and lower portions of the stacked dielectric sheets 111′.

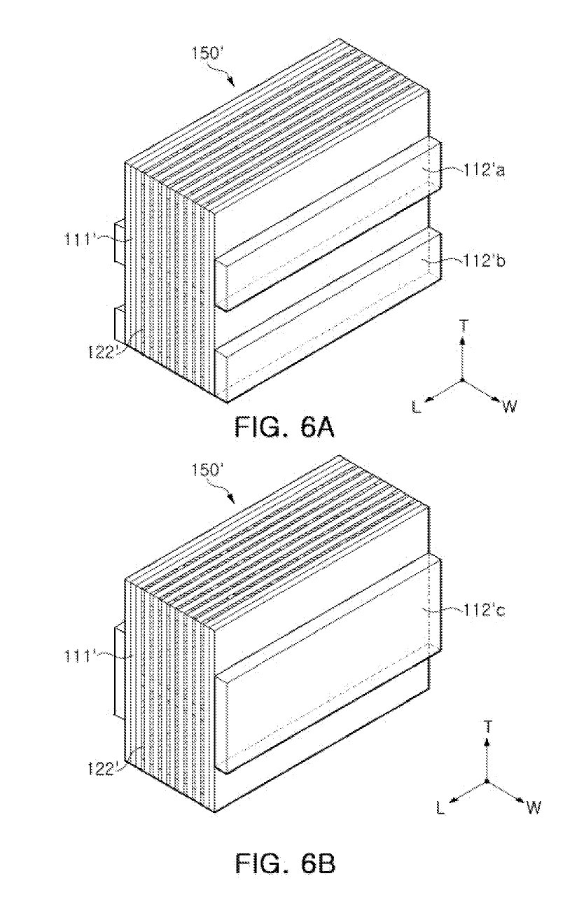

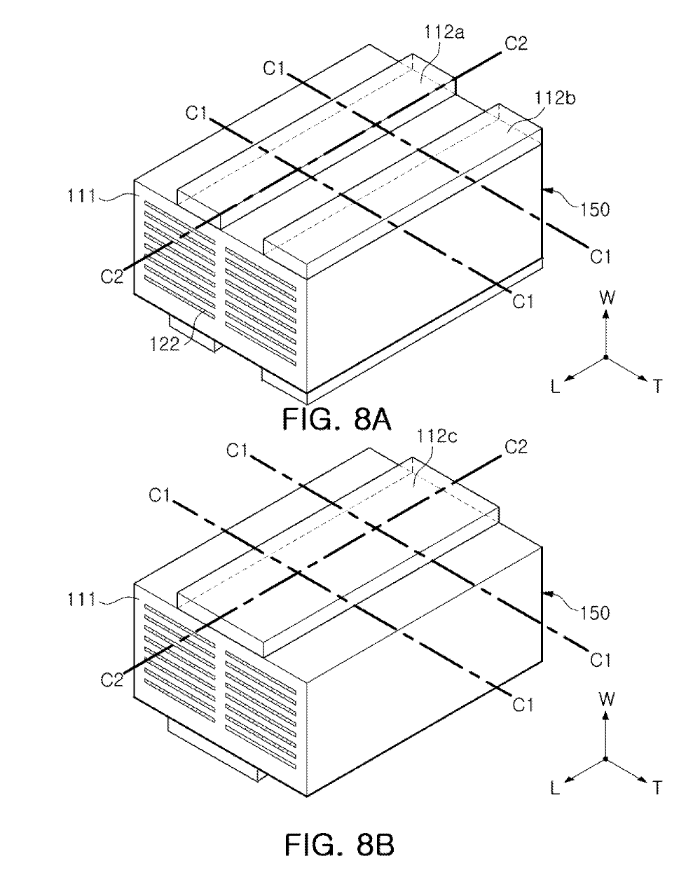

Referring to FIG. 6A, dielectric sheets 112′a and 112′b maybe additionally formed on portions of opposite side surfaces of the multilayer body 150′ in the width direction. The dielectric sheets 112′a and 112′b may be extended in the thickness direction approximately from each boundary between adjacent units to only side of each boundary. Adjacent units may be separated into individual electronic components by a cutting process along a cutting line C2-C2 at the boundary illustrated in FIG. 8A. Alternatively, referring to FIG. 6B, dielectric sheets 112′c may be additionally formed on portions of opposite side surfaces of the multilayer body 150′ in the width direction, and may also cover every other boundary between adjacent units if more than two units are arranged in the thickness direction. The adjacent units may be separated into individual electronic components by a cutting process along a cutting line C2-C2 at the every other boundary illustrated in FIG. 8B.

The dielectric sheets 112′a, 112′b, and 112′c additionally formed on opposite side surfaces of the multilayer body 150′ may be subjected to a sintering process, thereby forming attachment parts 112 for preventing a ceramic body 110 from leaning.

A height Ta and a width of the formed attachment part 112 may be adjusted by adjusting the heights of the dielectric sheets 112′a, 112′b, and 112′c and the numbers of stacked dielectric sheets 112′a, 112′b, and 112′c.

As illustrated in FIGS. 6A and 6B, the dielectric sheets 112′a, 112′b, and 112′c additionally stacked on opposite side surfaces of the multilayer body 150′ may be formed on portions of opposite side surfaces of the multilayer body 150′ so as to have a height lower than a height of an individual electronic component provided when the multilayer body 150′ is cut into individual electronic components.

The dielectric sheets 112′a, 112′b, and 112′c additionally stacked on opposite side surfaces of the multilayer body 150′ may be formed of a barium titanate (BaTiO₃)-based material, a lead complex perovskite-based material, a strontium titanate (SrTiO₃)-based material, or the like, and among them, barium titanate (BaTiO₃) powder may be preferable. However, the dielectric sheets 112′a, 112′b, and 112′c are not limited thereto.

In an exemplary embodiment of the present disclosure illustrated in FIG. 6A, during the cutting of the multilayer body 150′ into individual electronic components, the dielectric sheets 112′a and 112′b may be only cut in a thickness (T) direction of the multilayer body 150′ (see FIG. 8A).

In an exemplary embodiment of the present disclosure illustrated in FIG. 6B, during the cutting of the multilayer body 150′ into individual electronic components, the dielectric sheets 112c′ may be cut in thickness (T) and length (L) directions of the multilayer body 150′ (see FIG. 8B).

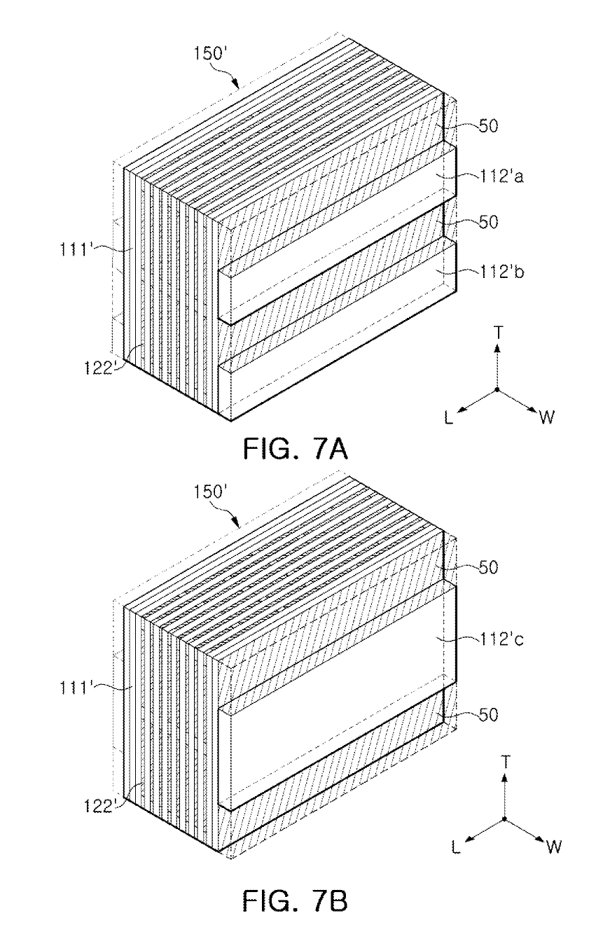

Referring to FIGS. 7A and 7B, an organic material 50 may be provided on regions of opposite side surfaces of the multilayer body 150′ in which the dielectric sheets 112′a, 112′b, and 112′c are not additionally formed.

Deformation of the additionally formed dielectric sheets 112′a, 112′b, and 112′c caused by compression during a compression process of the multilayer body 150′ may be prevented by providing the organic material 50.

The organic material 50 may be a material that may be thermally decomposed to thereby be removed later at a sintering temperature at the time of sintering the multilayer body 150′.

Subsequently, the multilayer body 150′ maybe sintered, thereby forming a ceramic multilayer body 150 in which internal electrodes 121 and 122 are disposed.

Although not limited thereto, the sintering may be performed at 1100° C. to 1300° C. under an N2—H2 atmosphere.

The organic material 50 may be removed by the sintering.

After providing the organic material 50 in the regions in which the dielectric sheets 112′a, 112′b, and 112′c are not formed and compressing the multilayer body 150′ so that the dielectric sheets 112′a, 112′b, and 112′c are not deformed, the organic material 50 may be removed by the sintering.

Meanwhile, the dielectric sheets 112′a, 112′b, and 112′c may form attachment parts 112a, 112b, and 112c on opposite side surfaces of the ceramic multilayer body 150 by the sintering.

Referring to FIGS. 8A and 8B, the ceramic multilayer body 150 maybe cut into individual electronic components along C1-C1 cutting lines and a C2-C2 cutting line, thereby forming ceramic bodies 110 of which the attachment parts 112 are formed on the opposite side surfaces 1 and 2.

The ceramic body 110 may be formed to have a thickness T larger than a width W, and the attachment parts 112 formed to a height lower than a thickness of the ceramic body 110 in the thickness direction may be formed on the opposite side surfaces 1 and 2 of the ceramic body 110 in the width (W) direction.

A stacking direction of the internal electrodes 121 and 122 and the attachment parts 112 may be the width (W) direction of the ceramic body 110, and in a case in which the multilayer ceramic capacitor is mounted on aboard as described below, the multilayer ceramic capacitor may be mounted on the board so that the internal electrodes are disposed perpendicularly to the board.

Meanwhile, a manufacturing sequence is not limited to cutting the multilayer body 150′ into individual electronic components after performing the sintering. For example, although not illustrated, the multilayer body 150′ may be cut into individual electronic components and then sintered.

In the multilayer ceramic capacitor 100, according to the exemplary embodiment in the present disclosure, manufactured as described above, when a height of the attachment parts 112 is defined as Ta, Ta/T may satisfy 0.05≦Ta/T≦0.97.

Further, when a sum of widths of the ceramic body 110 and the attachment parts 112 is defined as Wb, W/Wb may satisfy 0.90≦W/Wb≦0.97.

Thereafter, external electrodes 131 and 132 may be formed on the end surfaces 3 and 4 in the length direction of the ceramic body 100 to which the internal electrodes 121 and 122 are exposed.

The external electrodes 131 and 132 may be formed using a conductive paste containing a conductive metal such as copper (Cu), silver (Ag), nickel (Ni), or the like, and be formed, for example, by a dipping method, or the like.

Since other features of the method of manufacturing a multilayer ceramic capacitor according to another exemplary embodiment in the present disclosure are the same as those of the above-mentioned multilayer ceramic capacitor according to the exemplary embodiment in the present disclosure, a detailed description thereof will be omitted.

### Board Having Multilayer Ceramic Capacitor

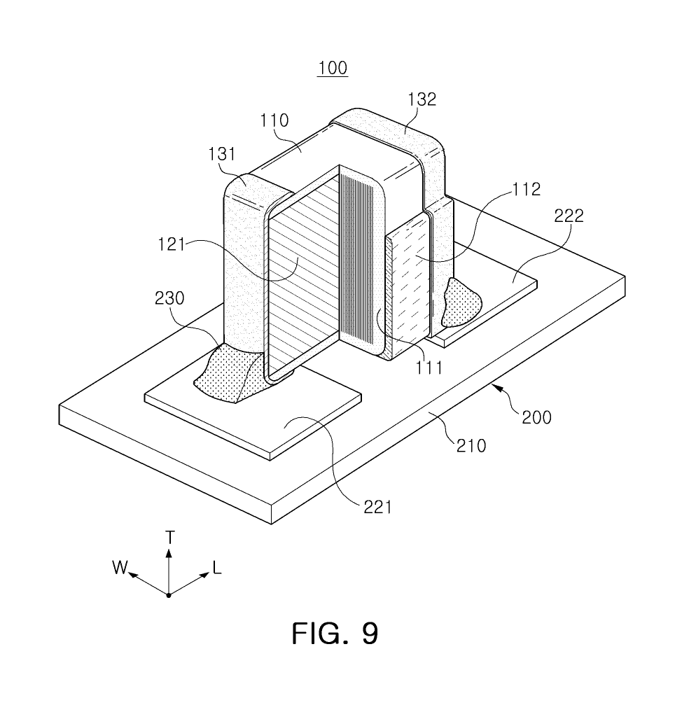

FIG. 9 is a perspective view illustrating a form in which the multilayer ceramic capacitor of FIG. 1 is mounted on a printed circuit board.

Referring to FIG. 9, a board 200 on which a multilayer ceramic capacitor 100 is mounted according to another exemplary embodiment in the present disclosure may include a printed circuit board 210 on which the internal electrodes 121 of the multilayer ceramic capacitor 100 are perpendicularly mounted, and the first and second electrode pads 221 and 222 formed on the printed circuit board 210 may be spaced apart from each other.

In this case, the multilayer ceramic capacitor 100 may be electrically connected with the printed circuit board 210 by soldering 230 in a state in which the first and second external electrodes 131 and 132 are positioned on the first and second electrode pads 221 and 222 so as to come in contact with each other, respectively.

As described above, the board 200 having a multilayer ceramic capacitor, according to another exemplary embodiment in the present disclosure, may be in a form in which a high capacitance multilayer ceramic capacitor 100 including the ceramic body 110 is mounted thereon, wherein when a length of the ceramic body is defined as L, a width thereof is defined as W, and a thickness thereof is defined as T, the ceramic body may satisfy T/W>1.0.

Further, as described above, on the board 200 on which a multilayer ceramic capacitor is mounted, according to another exemplary embodiment in the present disclosure, even though the multilayer ceramic capacitor 100 is mounted on the board, since the attachment parts 112 formed to a height less than the thickness T of the ceramic body 110 are formed on the opposite side surfaces 1 and 2 of the ceramic body 110 as described above, a leaning defect of the multilayer ceramic capacitor 100 may be prevented.

Therefore, the board including a multilayer ceramic capacitor having a high degree of capacitance and excellent reliability may be implemented.

Since other features of the board having a multilayer ceramic capacitor according to another exemplary embodiment in the present disclosure are the same as those of the above-mentioned multilayer ceramic capacitor according to the exemplary embodiment in the present disclosure, a detailed description thereof will be omitted.

As set forth above, according to exemplary embodiments in the present disclosure, when the multilayer ceramic capacitor having high capacitance is mounted on the board, leaning and tombstone defects may be prevented.

Therefore, the high capacitance multilayer ceramic capacitor having excellent reliability may be implemented.

While exemplary embodiments have been shown and described above, it will be apparent to those skilled in the art that modifications and variations could be made without departing from the scope of the present invention as defined by the appended claims.

What is claimed is:

1. A method of manufacturing a multilayer ceramic capacitor, the method comprising:
stacking dielectric sheets on which internal electrode patterns are printed, to form a multilayer body;
forming additional dielectric sheets on portions of first and second side surfaces, opposite to each other, of the multilayer body; and
sintering the multilayer body to form a ceramic body in which internal electrodes are disposed,
wherein the additionally formed dielectric sheets form attachment parts on opposite side surfaces of the ceramic body by the sintering of the multilayer body.

2. The method of claim 1, further comprising providing an organic material on regions of the first and second side surfaces of the multilayer body on which the additional dielectric sheets are not formed.

3. The method of claim 2, wherein the organic material is removed by the sintering of the multilayer body.

4. The method of claim 1, wherein T/W satisfies T/W>1.0, in which W is a width of the ceramic body and T is a thickness of the ceramic body.

5. The method of claim 1, wherein the attachment parts have a height less than a thickness of the ceramic body in a thickness direction of the ceramic body.

6. The method of claim 1, wherein Ta/T satisfies 0.05≦Ta/T≦0.97, in which T is a thickness of the ceramic body and Ta is a height of the attachment part.

7. The method of claim 1, wherein W/Wb satisfies 0.90≦W/Wb≦0.97, in which W is a width of the ceramic body and Wb is a sum of widths of the ceramic body and the attachment parts.

8. The method of claim 1, wherein the internal electrodes and the attachment parts are stacked in a width direction of the ceramic body.

9. A multilayer ceramic capacitor comprising:
a ceramic body including dielectric layers and satisfying T/W>1.0, in which W is a width of the ceramic body and T is a thickness of the ceramic body;
internal electrodes disposed in the ceramic body; and
attachment parts disposed on opposite side surfaces of the ceramic body in a width direction of the ceramic body and having a height Ta smaller than the thickness T of the ceramic body,
wherein the attachment parts are made of a dielectric material.

10. The multilayer ceramic capacitor of claim 9, wherein Ta/T satisfies 0.05≦Ta/T≦0.97.

11. The multilayer ceramic capacitor of claim 9, wherein W/Wb satisfies 0.90≦W/Wb≦0.97, in which Wb is a sum of widths of the ceramic body and the attachment parts.

12. The multilayer ceramic capacitor of claim 9, wherein the attachment parts is disposed only on a portion of each of the opposite side surfaces.

13. The multilayer ceramic capacitor of claim 9, wherein the attachment parts are formed of substantially the same materials as a material of the dielectric layers forming the ceramic body.

14. The multilayer ceramic capacitor of claim 9, wherein td satisfies 0.1 μm≦td≦0.8 μm, in which td is an average thickness of the dielectric layers.

15. The multilayer ceramic capacitor of claim 9, wherein a thickness of the internal electrode is 0.6 μm or less.

16. A method of manufacturing a multilayer ceramic capacitor, the method comprising:
alternatively stacking a plurality of dielectric sheets and a plurality of internal electrode patterns, so as to form a multilayer body;
forming additional dielectric sheets on a portion of each of opposite side surfaces of the multilayer body in a stacking direction of the plurality of dielectric sheets and the plurality of internal electrode patterns;
forming organic layers on the remaining portions of the opposite surfaces where the additional dielectric sheets are not formed; and
sintering the multilayer body, the additional dielectric sheets, and the organic layers,
wherein the organic layers are removed by sintering.

17. The method of claim 16, further comprising:
performing, in a first cut direction, a first cut of the multilayer body and the additional dielectric sheets along an edge of the additional dielectric sheets, or along a path which crosses the additional dielectric sheets and passes no internal electrode patterns; and
performing a second cut of the multilayer body and the additional dielectric sheets in a second cut direction perpendicular to the first cut direction,
wherein:
a plurality of multilayer bodies are formed by the first cut and the second cut, and attachment parts, formed of the additional dielectric sheets, are attached to opposite side surfaces of each multilayer body.

18. The method of claim 17, wherein T/W satisfies T/W>1.0, in which W is a width of one of the multilayer bodies determined in the stacking direction and T is a thickness of the one of the multilayer ceramic bodies determined in the second cut direction.

19. The method of claim 17, wherein Ta/T satisfies 0.05≦Ta/T≦0.97, in which T is a thickness of the ceramic body determined in the second cut direction and Ta is a height of the attachment part determined in the second cut direction.

20. The method of claim 17, wherein W/Wb satisfies 0.90≦W/Wb≦0.97, in which W is a width of the ceramic body determined in the stacking direction and Wb is a sum of widths of the ceramic body and the attachment parts determined in the stacking direction.
